(19) United States
(12) Patent Application Publication
(10) Pub. No.: US 2022/0186500 A1
(43) Pub. Date: Jun. 16, 2022

(54) COMBINATION AWNING AND STORM SHUTTER

(71) Applicant: YURI VASYLYNYN, Naples, FL (US)

(72) Inventor: YURI VASYLYNYN, Naples, FL (US)

(21) Appl. No.: 17/120,126

(22) Filed: Dec. 12, 2020

(51) Int. Cl. E04F 10/10; E06B 9/04; E06B 9/06

(52) U.S. Cl. CPC E04F 10/10; E06B 9/0638; E06B 9/0676; E06B 9/04

(57) ABSTRACT

A combination awning and shutter (1) having at least two panels (4, 5, 15, 16, 17) of substantially rectangular configuration foldably attached along contiguous sides so that when folded together and supported by support rods (8) or scissor hinges (18) and brackets (19) can be maintained in an angular awning position and when unfolded act as a storm or security shutter over a window or door opening and further securable by the support rods secured in eye bolts (11) on each side of an opening.

### FIELD OF THE INVENTION

This invention relates to awnings and storm shelters and more particularly to a foldable shutter that serves as a sun awning during normal weather and shutter during stormy weather.

### BACKGROUND OF THE INVENTION

Window coverings used in tropical climates, such as awnings and storm shutters, are used to provide shade, protection during storms and security when an owner is away for a season or period of time. Conventional awnings on homes and commercial buildings are generally fixed in place angularly over a window and although such awnings may provide some shade and protection from direct sunlight, such awnings provide little if no protection from storms.

Similarly, conventional shutters are installed or placed into operation on a permanent basis before an approaching storm or for security purposes and come in a variety of forms. Such shutters may take the form of louvers which may be attached to opposite sides of a window by hinges and pivot inwardly to cover a window. Other shutters consist of separate slats that must be inserted into tracks above an below a window. Some are motorized and are permanently encased in a holder above a window and powered downward to cover a window.

Perhaps the most basic window or door covering during storms consists of plywood sheets which are secured by screws around the sides of an opening which causes unsightly damage to a home when removed. Such conventional awnings and shutters are single purpose as none act as both awnings and shutters, most are time-consuming, labor-intensive or expensive to install, are unsightly and result in damage to the building on which they are installed.

In view of the above problems, a need exists for an apparatus that can serve as both an awning and a shutter, that is easy to install, that is attractive so it can be permanently installed over a door or window of a building and can quickly convert from an awning to a storm/security shutter and vice versa.

### SUMMARY OF THE INVENTION

The primary object of the present invention is to provide an apparatus that can serve as both an awning and shutter.

Another object of the present invention is to provide such an apparatus that can be easily and quickly converted from an awning to a shutter and vice versa.

An additional object of the present inventions is to provide such an apparatus that is attractive so it can be permanently installed and remain in place on a home or building year round.

An even further object of the present invention is to provide such an apparatus that is inexpensive and thus affordable for all homeowners.

The present invention accomplishes the above and other objects by providing a combination awning and shutter having at least two panels of rigid material of same size and substantially rectangular configuration, having four sides which are foldably or hingedly attached along contiguous sides. An uppermost panel is attachable on a side opposite its contiguous side to a building over a top of an opening. A lowermost panel folds over the uppermost panel in an awning mode and folds outward and downward in a shutter mode. Two support posts each having two ends, one end which can be removeably attached on outer sides of the uppermost panel and the other end which is removably attached to the building, are provided to hold the two panels in an angular awning position. A three panel version is provided to cover large openings, such as a door.

At least one of the two panels of rigid material comprise forming

The awning, shutter preferably have an outer sheet of steel, an inner sheet of aluminum and a layer of foam sandwiched between the two sheets. At least two brackets on each side of an opening into which one end of each support post can be attached to hold the combination awning and shutter in an angular awning position.

The support posts may be adjustable in length to enable the angle of the awing to be adjusted as desired. Eye bolts on each side of the opening being covered into which The support posts can be inserted to hold the shutters in a closed position over the opening.

One aspect of the combination awning and shutter may use a folding scissor bracket attached on a first end to each side of the uppermost panel proximate a bottom and attached to a building on second end to a building for holding the combination awning and shutter in an open position.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a perspective view of a combination awning and shutter of the present invention in an open awning mode over a window opening;

FIG. 2 is a is a perspective view of a combination awning and shutter of the present invention in a closed shutter mode over a window opening;

FIG. 3 is a perspective view of a three panel combination awning and shutter of the present invention in an open awning mode over a door;

FIG. 4 is a perspective view of a three panel combination awning and shutter of the present invention illustrating the order of unfolding the panels from an awning mode into a shutter mode;

FIG. 5 is a perspective view of the three panel combination awning and shutter of FIG. 3 in a close shutter mode over a door; and

FIG. 6 is a side view of the combination awning and shutter in an awning mode illustrating a scissor support bracket and shutter holding closure hook.

### DESCRIPTION OF THE PREFERRED EMBODIMENTS

For purposes of describing the preferred embodiment, the terminology used in reference to the numbered accessories in the drawings is as follows:
1. combination awning and shutter, generally
2. building
3. window
4. uppermost panel
5. lowermost panel
6. building attachment hinges
7. folding hinges
8. support rods
9. brackets
10. shutter closure hook
11. eye bolt
12. multi-layer panel awning/shutter
13. door
14. top building attachment hinges
15. uppermost panel
16. lowermost panel
17. middle panel
18. folding scissor hinge
19. brackets

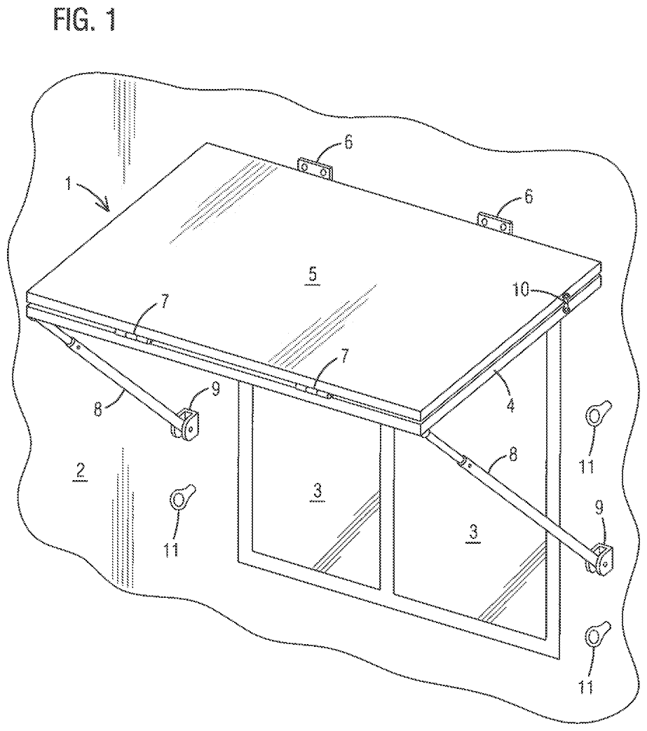

Discussing the preferred embodiments of the combination awning and shutter apparatus of the present invention, reference is made to the drawings. FIG. 1 illustrates the apparatus as it would appear in use as an awning 1 when attached to a building 2 over a window 3. As shown the awning/shutter 1 has two panels, an uppermost panel 4 and a lowermost panel 5. The lowermost panel 5 is attached to the uppermost panel 4 by hinges 7 and is folded over on top of the uppermost panel 4 when the awning/shutter is in an awning mode. The uppermost panel 4 is attached to a building by hinges 6 mounted on a topside of the uppermost panel 4. The panels 4 and 5 are secured together by a closure lock 10. The apparatus is maintained and supported in an awning mode by support rods 8 which are attached at a building end to each side of a window 3 by brackets 9 and at a corner of an outer end of the uppermost panel 4.

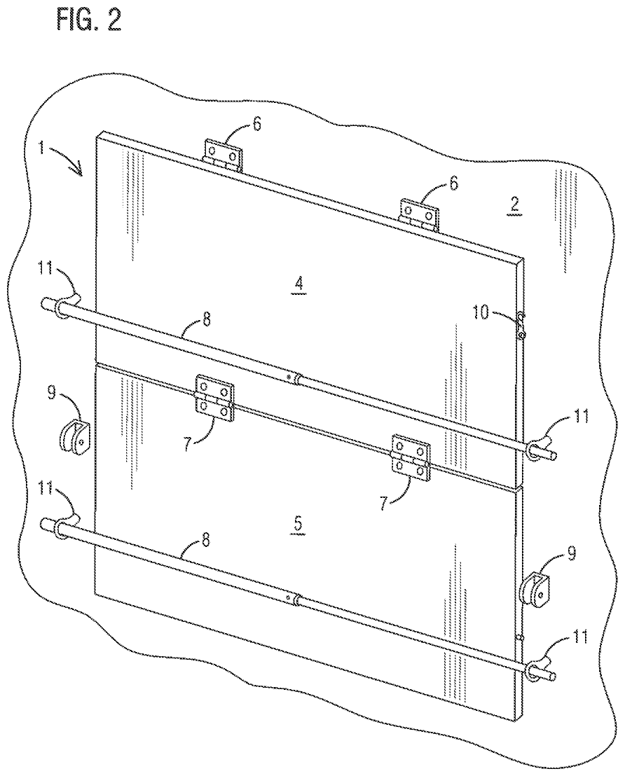

FIG. 2 illustrates the awning/shutter 1 in a closed shutter mode over the window opening of the building 2. In the shutter mode the support rods 8 are removed and the lowermost panel 5 is rotated downward and outward and the upper most panel 4 downward on hinges 7 to fully cover the window opening. The support rods 8 now serve another purpose which is to secure the shutter 1 in a close position by acting as crosspieces secured at each side through eye hooks 11.

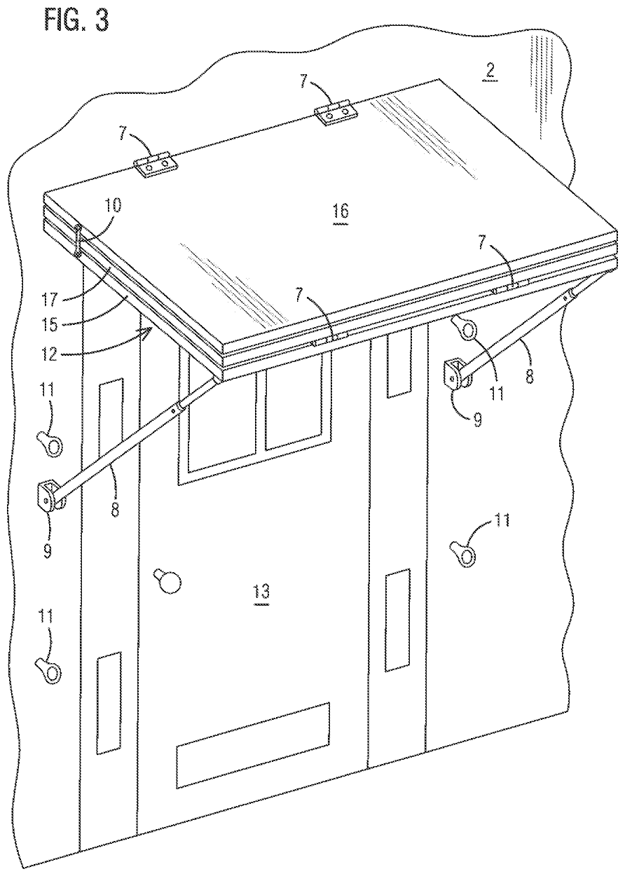

FIG. 3 illustrates a three panel version of the awning/shutter apparatus of the present invention that can be used to protect and cover large openings, such as doors. In this version the awning/shutter 12 has three panels, an uppermost panel 15, a middle panel 17 and a lowermost panel 16. The uppermost panel 15 is attached to a building 2 over a door 13 by hinges 14. Similar to the window version shown in FIG. 1, the awning, shutter is supported in an awning mode by support rods 8 secured at a building end to brackets and at outer corners of the lowermost panel 16. Like the window support rods 8 these rods could be adjustable in length to vary the angle of the awning 12 in relation to the building to block direct sunlight as desired. Also like the window version the panels of the door awning/shutter could be secured together by closure hooks 10 on a side of the panels.

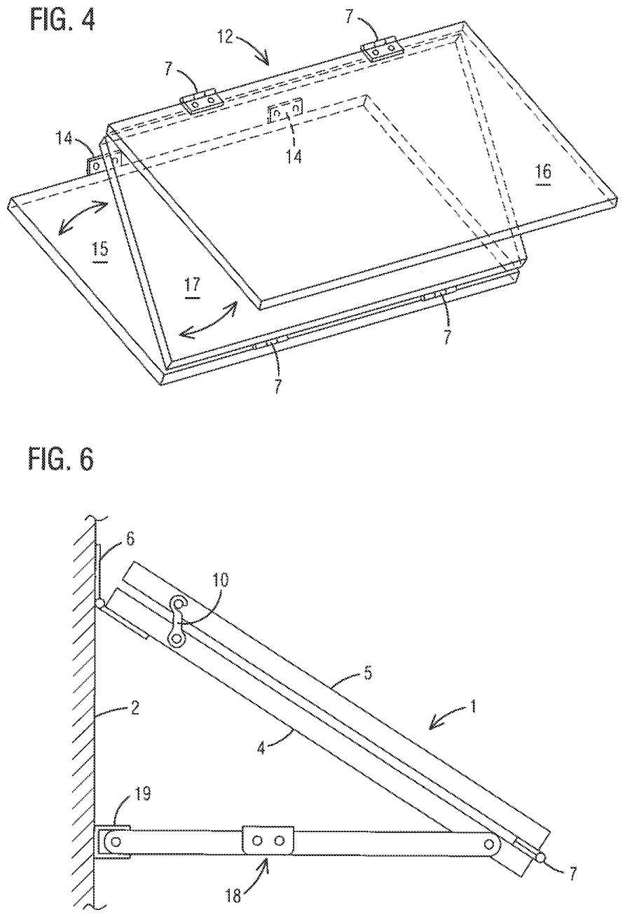

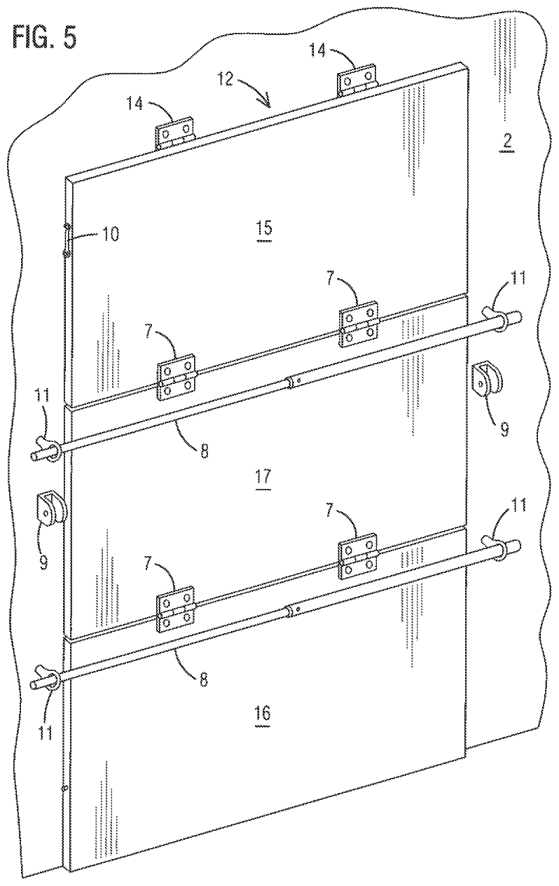

The importance of the order of unfolding the panels of the three panel version of the awning/shutter is illustrated in FIG. 4. As illustrated the middle panel 17 is rotated outward from the uppermost panel 15 via hinges 7 while the lowermost panel 16 is rotated outward and downward until it covers the entire door 13 as illustrated in FIG. 5.

FIG. 5 illustrates the three panel version of the awning/shutter 12 in a closed shutter mode with the uppermost panel 16 still attached at a top end over a door by hinges 14, the middle panel 17 attached below it by folding hinges 7 and the lowermost panel 15 attached by folding hinges 7 below it. Again, as in the two panel window version of the awning/shutter the support rods 8 perform a dual function, namely as securing rods by being placed across the panels and secured to the building by eye bolts 11.

The final drawing in FIG. 6 is an enlarged side view of the two panel window version of the awning/shutter 1 wherein the bottom attachment is not support rods but rather a folding scissor hinge 18 attached to a building 2 by brackets 19. The use of a scissor bracket 18 would allow the awning/shutter to be folded inward to convert to a closed shutter mode without having to remove support rods merely by unhooking the closure hook 10, rotating the lowermost panel 4 downward while pushing upward on the scissor bracket 18 to collapse it into a folding mode.

The rigid panels forming the awning/shutters of the present invention are preferably multi-layer, having outer layers of metal with expandable foam insulation sandwiched between the two metal layers that would provide cooling insulation in hot climates and seasons as well as sound dampening during storms. For aesthetic appearance purposes the outer surfaces of the panels which are visible when the awning/shutters are in a closed shutter mode would be painted a desired color to fit the appearance of a house of building, whereas the inner layer could be a shiny aluminum or also painted as desired.

It is to be understood that while a preferred embodiment of the invention is described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

Having thus described my invention, I claim:

1. A combination awning and shutter comprising:
at least two panels of rigid material of same size and substantially rectangular configuration having four sides which are foldably attached along contiguous sides;
an uppermost panel attachable on a side opposite its contiguous side to a building over a top of an opening; and
two support posts each having two ends, one end which can be removably attached to outer sides of the uppermost panel and the other end which is removably attached to the building so as to hold the two panels in an awning mode and which serve as support rods in a closed shutter mode.

2. The combination awning and shutter of claim 1 wherein the two panels are foldably attached along contiguous sides by at least one hinge.

3. The combination awning and shutter of claim 1 wherein at least one of the two panels of rigid material comprises an outer sheet of steel, an inner sheet of aluminum and a layer of foam sandwiched between the two sheets.

4. The combination awning and shutter of claim 1 further comprising brackets on each side of an opening into which one end of each support post can be attached to hold the combination awning and shutter in an angular awning opposition.

5. The combination awning and shutter of claim 4 wherein the support posts are adjustable in length to enable the angle of the awing to be adjusted as desired.

6. The combination awning and shutter of claim 1 further comprising eye bolts on each side of the opening being covered into which the support posts can be inserted to hold the shutters in a closed position over the opening.

7. A combination awning and shutter comprising:
at least two panels of rigid material of same size and substantially rectangular configuration having four sides which are foldably attached along contiguous sides;
an uppermost panel attachable on a side opposite its contiguous side to a building over a top of an opening; and
a folding scissor bracket attached on a first end to each side of the tippet most panel proximate a bottom and attached to a building on second end to a building for holding the combination awning and shutter in an open position.

8. The combination awning and shutter of claim 1 further comprising eye bolts on each side of the opening being covered into which the support posts can be inserted to hold the shutter in a closed position over the opening.

9. The combination awning and shutter of claim 1 further comprising a closure hook on at least one side to hold the panels together when the combination awning and shutter is in an awning mode.

10. The combination awning and shutter of claim 7 further comprising a closure hook on at least one side to hold the panels together when the combination awning and shutter is in an awning mode.
